(19) United States
(12) Patent Application Publication
(10) Pub. No.: US 2010/0182223 A1
(43) Pub. Date: Jul. 22, 2010

(54) ORGANIC LIGHT EMITTING DISPLAY DEVICE

(75) Inventors: JONG-HYUN CHOI, Yongin-city (KR); JANG-SOON IM, Yongin-city (KR); SUNG-HO KIM, Yongin-city (KR); ILJEONG LEE, Yongin-city (KR)

Correspondence Address: ROBERT E. BUSHNELL & LAW FIRM, 2029 K STREET NW, SUITE 600, WASHINGTON, DC, 20006-1004, US

(73) Assignee: SAMSUNG MOBILE DISPLAY CO., LTD., Yongin-city (KR)

(21) Appl. No.: 12/691,907

(22) Filed: Jan. 22, 2010

(30) Foreign Application Priority Data
Jan. 22, 2009 (KR) 10-2009-0005528

(51) Int. Cl. G09G 3/30

(52) U.S. Cl. 345/76

(57) ABSTRACT

An organic light emitting display device that includes a plurality of signal lines and a plurality of scan lines, a plurality of pixels arranged at intersections of ones of the plurality of signal lines and ones of the plurality of scan lines, a scan driver to supply scan signals to the plurality of scan lines, the scan driver including a first plurality of thin film transistors and a data driver to supply data signals to the plurality of signal lines, the data driver including a second plurality of thin film transistors, wherein each of said plurality of pixels includes a first thin film transistor, a second thin film transistor and an organic light emitting diode, the first transistor being connected to the organic light emitting diode, the first transistor having an active layer made out of an oxide semiconductor, the second transistor, the first plurality of thin film transistors and the second plurality of thin film transistors each having an active layer made out of poly-silicon.

### CLAIM OF PRIORITY

This application makes reference to, incorporates the same herein, and claims all benefits accruing under 35 U.S.C. §119 from an application earlier filed in the Korean Intellectual Property Office on 22 Jan. 2009 and there duly assigned Serial No. 10-2009-0005528.

### BACKGROUND OF THE INVENTION

1. Field of the Invention

The present invention relates to an organic light emitting display device that realizes a drive transistor using an oxide thin film transistor.

2. Discussion of Related Art

An organic light emitting display device is a next-generation display device having self-light emitting characteristics, excellent visual angle, improved contrast, improved response time, and lower power consumption as compared to a liquid crystal display (LCD) device.

An organic light emitting display device includes organic light emitting diodes is each having an anode electrode, an organic thin film layer, and a cathode electrode. Such an organic light emitting display device can be realized by a passive matrix device in which organic light emitting diodes are connected between scan lines and signal lines so as to form a pixel or by an active matrix device in which the operations of pixels are controlled by thin film transistors (TFT) functioning as switches.

A thin film transistor used in an active matrix device generally include an active layer providing a channel region, a source region, and a drain region, and a gate electrode formed on the channel region and electrically insulated from the active layer by a gate insulating layer. The active layer of the thin film transistor is generally made out of a semiconductor layer such as amorphous silicon or poly-silicon.

Here, when an active layer is made out of amorphous silicon, it is difficult to realize a high speed drive circuit due to low mobility. On the other hand, when an active layer is made out of poly-silicon, since its mobility is high but its threshold voltage is not uniform due to its polycrystalline nature, a compensation circuit for compensating for the distribution of the mobility and threshold voltage is necessary. In other words, when the active layer is made out of poly-silicon, since a complex compensation circuit including a plurality of thin film transistors and a plurality of capacitors is required, the manufacturing costs are increased, the productivity of the active layer is lowered and the number of used masks is increases as compared to that of amorphous silicon active layer design.

Meanwhile, since a conventional manufacturing method for a thin film transistor using low temperature poly-silicon (LTPS) requires a process such as laser thermal processing that requires high costs and has a difficulty in controlling characteristics thereof, it cannot be easily applied to a substrate of a wide area.

In order to solve the above problems, studies on the use of an oxide semiconductor layer as an active layer are recently being carried out. For example, Japanese Patent Laid-Open No. 2004-273614 discloses a thin film transistor in which an oxide semiconductor mainly consists of zinc oxide (ZnO) as an active layer. The oxide semiconductor mainly consisting of zinc oxide (ZnO) is considered to be amorphous and stable. When such an oxide semiconductor is used as an active layer, a thin film transistor can be manufactured at a low temperature of below 350 degrees Celsius using conventional equipment without the need of separate equipment and without the need of extra processes such as ion implantation.

However, the device characteristics of such thin film transistors using oxide semiconductors as active layers are different according to the structures of transistors, and the thin film transistors are generally restricted to N-type transistors. Furthermore, considering the characteristics and uniformity of a device, when a thin film transistor using an oxide semiconductor as an active layer are applied to a thin film transistor having the structure of an inverted staggered bottom gate, the mobility of electric field effect is lower than 20 cm²/Vs. Accordingly, when a thin film transistor utilizing an oxide semiconductor is to be applied to a display panel, its degree of integration becomes lower than that of amorphous silicon or poly-silicon.

### SUMMARY OF THE INVENTION

Therefore, the present invention is made in view of the above problems and provides an organic light emitting display device that combines advantages of oxide transistors with that of poly-silicon transistors by realizing drive transistors connected to organic light emitting devices of pixels using oxide transistors and realizing the remaining transistors using poly-silicon transistors, thereby improving performance and productivity and reducing manufacturing cost.

According to an aspect of the present invention, there is provided an organic light emitting display device that includes a plurality of signal lines and a plurality of scan lines, a plurality of pixels arranged at intersections of ones of the plurality of signal lines and ones of the plurality of scan lines, a scan driver to supply scan signals to the plurality of scan lines, the scan driver including a first plurality of thin film transistors and a data driver to supply data signals to the plurality of signal lines, the data driver including a second plurality of thin film transistors, wherein each of said plurality of pixels includes a first thin film transistor, a second thin film transistor and an organic light emitting diode, the first transistor being connected to the organic light emitting diode, the first transistor having an active layer comprised of an oxide semiconductor, the second transistor, the first plurality of thin film transistors and the second plurality of thin film transistors each having an active layer comprised of poly-silicon.

The first transistor can be a drive transistor of a corresponding pixel. The second transistor can be a switching transistor of a corresponding pixel. The first transistor can have an inverted staggered bottom gate structure. The first transistor can include a gate electrode, a gate insulating layer arranged on the gate electrode, an oxide semiconductor layer arranged on the gate insulating layer at a location that corresponds to the gate electrode and a source electrode and a drain electrode electrically connected to the oxide semiconductor layer.

The second transistor can have a top gate structure. The second transistor can include a poly-silicon layer, an insulating layer arranged on the poly-silicon layer, a gate electrode arranged on the insulation layer at a location that corresponds to the poly-silicon layer and a source electrode and a drain electrode electrically connected to the poly-silicon layer. The gate electrode of the first transistor can be arranged on a same layer as the gate electrode of the second transistor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIGS. 1A and 1B are a plan view and a sectional view respectively illustrating an organic light emitting display device according to an embodiment of the present invention;

FIG. 2 is a circuit diagram illustrating an embodiment of a pixel of FIG. 1A; and

FIG. 3 is a sectional view illustrating a first transistor of FIG. 2, an organic light emitting diode (OLED) connected to the first transistor, and a second transistor.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

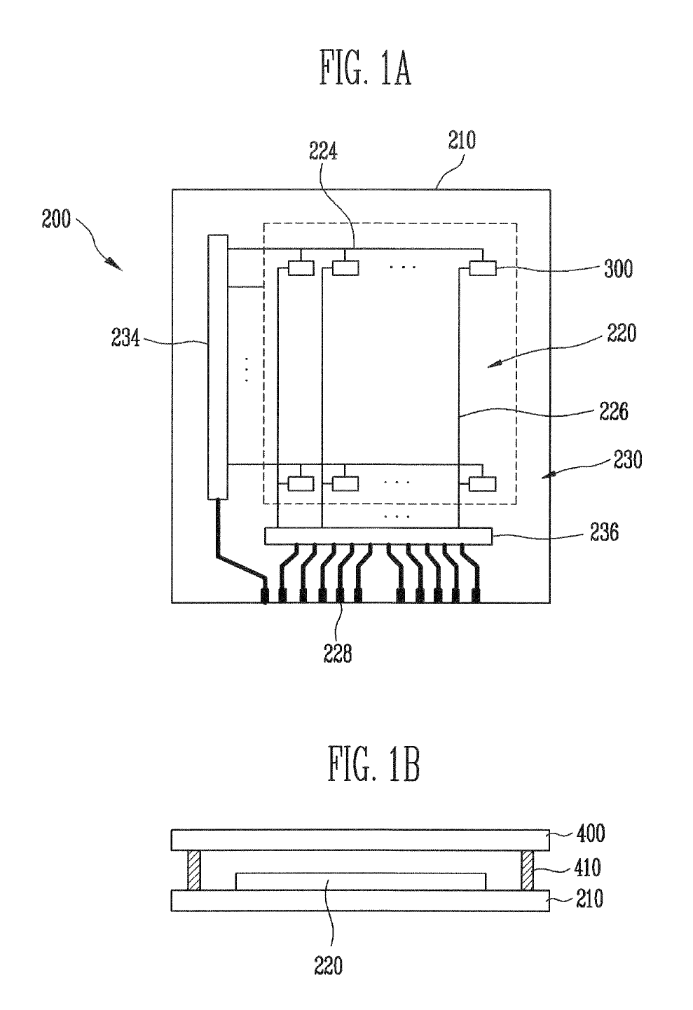

Turning now to FIGS. 1A and 1B, FIGS. 1A and 1B are a plan view and a sectional view respectively illustrating an Organic light emitting display device 200 according to an embodiment of the present invention. Referring to FIG. 1A, a substrate 210 is defined by a pixel region 220 and a non-pixel region 230 surrounding the pixel region 220. A plurality of pixels 300 connected in a matrix manner between scan lines 224 and signal lines 226 are formed in the pixel region 220 of the substrate 210. Scan lines 224 and signal lines 226 extending from the scan lines 224 are formed in the pixel region 220. A power supply line (not shown) for the operations of the pixels 300, and a scan driver 234 and a data driver 236 for processing signals provided from the outside through pads 228 and supplying the processed signals to the scan lines 224 and the signal lines 226 are formed in the non-pixel region 230 of the substrate 210. Each pixel 300 includes a pixel circuit having a plurality of thin film transistors and an organic light emitting diode (OLED) connected to the pixel circuit.

Referring to FIG. 1B, a sealing substrate 400 for sealing the pixel region 220 is disposed over the substrate 210 where the pixels 300 are formed, and the panel 200 is finished by adhering the sealing substrate 400 to the substrate 210 with a sealing material 410.

The pixels 300, the scan driver 234, and the data driver 236 formed on the substrate 210 includes a plurality of thin film transistors. In the embodiment of the present invention, of the thin film transistors of each pixel, a drive transistor connected to an organic light emitting diode is realized using an oxide transistor where an active layer is made out of an oxide semiconductor. In the embodiment of the present invention, the remaining transistors, that is, other thin film transistors (for example, switching transistors) of the pixels, and thin film transistors of the scan driver 234 and the data driver 236 are realized using poly-silicon transistors where active layers are made out of poly-silicon.

In other words, advantages of oxide transistors and poly-silicon transistors are combined in the design of the panel 200 to improve the productivity of an organic light emitting display device and reduce the manufacturing cost of the organic light emitting display device.

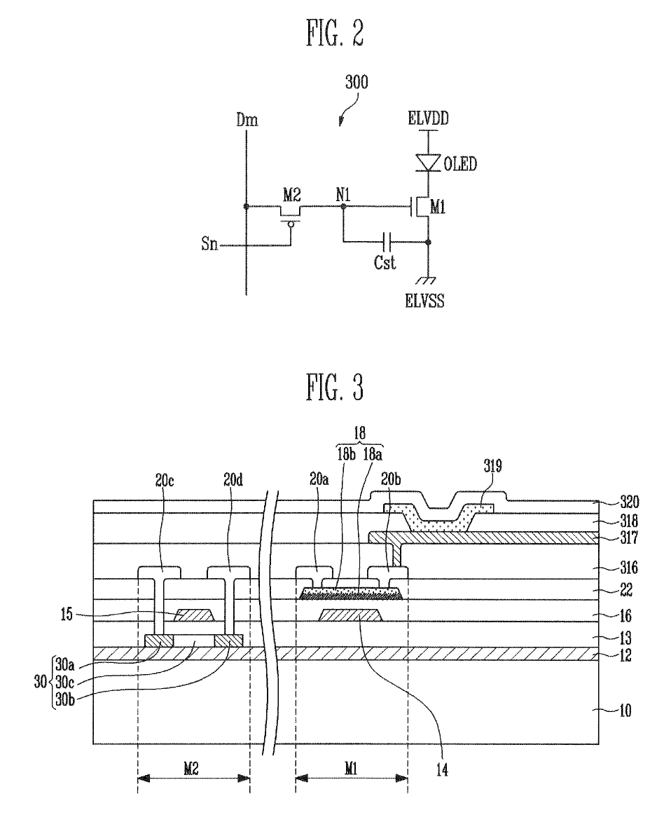

Turning now to FIG. 2, FIG. 2 is a circuit diagram illustrating an embodiment of a pixel of FIG. 1. The pixel circuit illustrated in FIG. 2 is only one embodiment of the present invention, and a pixel circuit of an organic light emitting display device according to the present invention is not limited thereto.

Referring to FIG. 2, the pixel circuit includes a first transistor M1 as a drive transistor, a second transistor M2 as a switching transistor, and a capacitor Cst. Here, the first transistor M1 is an N-type oxide transistor, and the second transistor M2 is a poly-silicon transistor. Meanwhile, although the second transistor M2 is illustrated as a P-type transistor in FIG. 2, the embodiment of the present invention is not necessarily limited thereto.

The first and second transistors M1 and M2 each include a source electrode, a drain electrode, and a gate electrode, respectively. The source electrode and the drain electrode are physically the same that and are indicated by first and second electrodes respectively, while the capacitor Cst includes a first terminal and a second terminal.

The first electrode of the first transistor M1 is connected to the cathode electrode of the organic light emitting diode (OLED) and the second electrode of the first transistor M1 is connected to a second power source ELVSS. The gate of first transistor M1 is connected to the first node N1.

The first electrode of the second transistor M2 is connected to a signal line Dm and the second electrode of the second transistor M2 is connected to the first node N1. The gate of second transistor M2 is connected to a scan line Sn to selectively transmit a data signal selectively flowing through the signal line Dm according to a scan signal transmitted through a scan line Sn.

The first terminal of the capacitor Cst is connected to the second power source ELVSS and the second terminal of the capacitor Cst is connected to the first node N1 in order to maintain the voltage between the gate and source of the first transistor M1 for a predetermined period of time. Then, the current corresponding to the voltage maintained by the capacitor Cst flows to the organic light emitting diode (OLED) in order to allow the organic light emitting diode (OLED) to emit light.

According to the present invention, a problem caused by a conventional transistor realized using a poly-silicon transistor is overcome by realizing the first transistor M1 using an oxide semiconductor. In other words, device characteristics such as a non-uniform threshold voltage can be overcome. In addition, a thin film transistor can be manufactured at a low temperature of 350 degrees Celsius using conventional equipment without the need for separate equipment and extra process steps such as ion implantation.

Furthermore, high speed switching operations can be realized by requiring that the transistors of the scan driver and the data driver as well as second transistor M2 be made to include a poly-silicon active layer. Therefore, advantages of oxide transistors and poly-silicon transistors are combined during manufacturing of a panel, thereby enhancing the performance and productivity of an organic light emitting display device and reducing the manufacturing cost of the organic light emitting display device.

Turning now to FIG. 3, FIG. 3 is a sectional view illustrating the first transistor, the organic light emitting diode connected to the first transistor M1 and the second transistor M2 of FIG. 2. The structure of the second transistor illustrated in FIG. 3 is the same as the structure of the thin film transistors of the scan driver and the data driver. Here, as an example, the first transistor M1 is an oxide thin film transistor having the structure of an inverted staggered bottom gate and the second transistor M2 is a poly-silicon thin film transistor having the structure of a top gate.

Referring to FIG. 3, a buffer layer 12 is formed on a substrate 10 and a poly-silicon layer 30 used as an active layer of the second transistor M2 is formed on the buffer layer 12. The poly-silicon layer 30 is formed by depositing and crystallizing an amorphous silicon layer. A source region 30a and a drain region 30b are formed in the poly-silicon layer 30 through ion implantation. Accordingly, the poly-silicon layer 30 includes a source region 30a, a drain region 30b, and a channel region 30c between the source region 30a and the drain region 30b.

Thereafter, an insulating layer 13 is formed on the poly-silicon layer 30, and the gate electrode 14 of the first transistor M1 and the gate electrode 15 of the second transistor M2 are formed on the insulating layer 13. The gate electrode 15 of the second transistor M2 is formed at a location that overlaps a channel region 30c of the poly-silicon layer 30, and the gate electrode 14 of the first transistor M1 is formed at a location that overlaps an oxide semiconductor layer 18 formed later.

In other words, in the embodiment of the present invention, the first transistor M1 is an oxide thin film transistor having the structure of an inverted staggered bottom gate and the second transistor M2 is a poly-silicon thin film transistor having the structure of a top gate. The gate electrodes 14 and 15 of the transistors are formed on the same layer. Through this, the mask process is simplified during formation of the gate electrodes.

Thereafter, a gate insulating layer 16 is formed together with the gate electrodes 14 and 15. An oxide semiconductor layer 18 providing a channel region, a source region, and a drain region is formed on the gate insulating layer 16 at a location that overlaps the gate electrode 14 of the first transistor M1.

The oxide semiconductor layer 18 mainly consists of zinc oxide (ZnO) and is a GaInZnO (GIZO) layer where gallium (Ga) and indium (In) are dopants. Then, the GIZO layer includes a lower portion 18a having a carrier density of 10¹⁵ to 10¹⁷/cm³ and an upper portion having a carrier density of 10¹² to 10¹⁵/cm³.

A passivation layer 22 is formed on the poly-silicon layer 30 and the oxide semiconductor layer 18, and via-holes are formed in regions (corresponding to the source region and the drain region) of the passivation layer 22. The source and drain electrodes 20c, 20d, 20a, and 20b formed on the passivation layer 22 make contact with the source and drain regions of the poly silicon layer 30 and the oxide semiconductor layer 18.

A planarization layer 316 for planarization of a surface is formed on the passivation layer 22, and a via-hole is formed in the planarization layer 316 so as to expose one of the source and drain electrode 20a and 20b of the first transistor M|. A first electrode 317 of an organic light emitting diode connected to the one of the source and drain electrode 20a and 20b of the first transistor M1 though the via-hole formed in the planarization layer 316.

A pixel defined layer 318 is formed on the planarization layer 316 so that a region (light emitting region) of the first electrode 317 can be exposed, and an organic thin film layer 319 is formed on the exposed portion of the first electrode 317. A second electrode 320 is formed on the pixel defined layer 318 and on the organic thin film layer 319.

While the present invention has been described in connection with certain exemplary embodiments, it is to be understood that the invention is not limited to the disclosed embodiments, hut, on the contrary, is intended to cover various modifications and equivalent arrangements included within the spirit and scope of the appended claims, and equivalents thereof.

What is claimed is:

1. An organic light emitting display device, comprising:
a plurality of signal lines and a plurality of scan lines;
a plurality of pixels arranged at intersections of ones of the plurality of signal lines and ones of the plurality of scan lines;
a scan driver to supply scan signals to the plurality of scan lines, the scan driver including a first plurality of thin film transistors; and
a data driver to supply data signals to the plurality of signal lines, the data driver including a second plurality of thin film transistors,
wherein each of said plurality of pixels includes a first thin film transistor, a second thin film transistor and an organic light emitting diode, the first transistor being connected to the organic light emitting diode, the first transistor having an active layer comprised of an oxide semiconductor, the second transistor, the first plurality of thin film transistors and the second plurality of thin film transistors each having an active layer comprised of poly-silicon.

2. The organic light emitting display device of claim 1, wherein the first transistor is a drive transistor of a corresponding pixel.

3. The organic light emitting display device of claim 1, wherein the second transistor is a switching transistor of a corresponding pixel.

4. The organic light emitting display device of claim 1, wherein the first transistor has an inverted staggered bottom gate structure.

5. The organic light emitting display device of claim 4, wherein the first transistor comprises:
a gate electrode;
a gate insulating layer arranged on the gate electrode;
an oxide semiconductor layer arranged on the gate insulating layer at a location that corresponds to the gate electrode; and
a source electrode and a drain electrode electrically connected to the oxide semiconductor layer.

6. The organic light emitting display device of claim 1, wherein the second transistor has a top gate structure.

7. The organic light emitting display device of claim 6, wherein the second transistor comprises:
a poly-silicon layer;
an insulating layer arranged on the poly-silicon layer;
a gate electrode arranged on the insulation layer at a location that corresponds to the poly-silicon layer; and
a source electrode and a drain electrode electrically connected to the poly-silicon layer.

8. The organic light emitting display device of claim 1, wherein a gate electrode of the first transistor is arranged on a same layer as a gate electrode of the second transistor.
